(19) United States
(12) Patent Application Publication
(10) Pub. No.: US 2023/0032663 A1
(43) Pub. Date: Feb. 2, 2023

(54) SPRINKLER SYSTEM FOR A MATERIALS DISPOSAL CHUTE AND A METHOD OF USING THE SAME

(71) Applicant: CHAZEM MANUFACTURING, LLC, Waldork, MD (US)

(72) Inventors: Hadi Camille BOUSTANI, Bethesda, MD (US); Richard Allen WOOD, Gambrills, MD (US)

(73) Assignee: CHAZEM MANUFACTURING, LLC, Waldork, MD (US)

(21) Appl. No.: 17/444,198

(22) Filed: Aug. 2, 2021

(51) Int. Cl. A62C 3/04; A62C 35/68; B65G 69/18

(52) U.S. Cl. CPC A62C 3/04; A62C 35/68; B65G 69/188

(57) ABSTRACT

A sprinkler system for a temporary chute used for disposal of construction materials during a construction or renovation project. The sprinkler system is releasably engaged with the temporary chute and is used to control dust within the chute, wash down the chute, and extinguish fires. A housing of the sprinkler system is releasably engaged with an intake hopper of the chute, placing an interior chamber of the housing in fluid communication with the chutes' tunnel. First and second sprinkler heads are located within the interior chamber. The first sprinkler head is temperature sensitive and automatically actuated when a threshold temperature is crossed. The second sprinkler head is manually activated by an operator to spray liquid into the tunnel to control dust or wash the interior surfaces of the chute. The sprinkler system and temporary chute are disengaged from the building once the construction or renovation project is completed.

### TECHNICAL FIELD

This disclosure is generally directed to chutes for conveying articles. More particularly, this disclosure relates to a temporary chute for disposing of construction materials, where the temporary chute extends from an upper story of a building to a lower story thereof. Specifically, the disclosure is directed to a sprinkler system that is releasably engageable with an upper end of the temporary chute and is actuated to deliver a volume of liquid into a tunnel defined by the temporary chute in order to extinguish a fire, to control dust, or to wash out the chute.

### BACKGROUND

### Background Information

During construction or renovation projects it is common to provide a temporary materials disposal chute to convey materials from upper stories of a building to a receptacle located on the ground. Typically, these temporary materials disposal chutes are secured proximate an inside or an outside wall of the building and are held in place by an appropriate supporting structure. An intake hopper is generally located at an uppermost end of the chute and workmen will place materials to be discarded into the intake hopper. Additional intake hoppers may be provided at intervals along the length of the chute. The materials introduced into the intake hoppers will travel down a tunnel defined by the chute to a discharge opening at a lower end of the chute. A receptacle may be placed on the ground under the discharge opening. The materials being thrown away drop through the chute under the force of gravity and into the receptacle or onto the ground if no receptacle is provided.

When the construction or renovation project is ended, the temporary chute will be dismantled and will be moved to the next construction or renovation site.

### SUMMARY

The present disclosure is directed to a sprinkler system that is releasably operatively engaged with a temporary chute used for disposal of construction materials during a construction or renovation project. The sprinkler system is used to control dust within the chute, wash down the chute, and extinguish any fires. A housing of the sprinkler system is releasably engaged with an intake hopper of the temporary chute, placing an interior chamber of the housing in fluid communication with the chutes' tunnel. First and second sprinkler heads are located within the interior chamber of the housing. The first sprinkler head is temperature sensitive and is automatically actuated when a threshold temperature is crossed, such as when a fire occurs in a receptacle placed below the lower end of the chute. The second sprinkler head is selectively manually operable and enables an operator to control dust in the chute tunnel or to wash out the chute when the project is over. When the construction or renovation project is completed, the sprinkler system is disengaged from the temporary chute, the temporary chute is dismantled, and then the temporary chute and sprinkler system are moved to a new job site.

In one aspect, an exemplary embodiment of the present disclosure may provide a sprinkler system for a temporary chute used for disposing of construction materials during a construction or renovation project, said sprinkler system comprising a housing adapted to be releasably operatively engaged with the temporary chute and, when the housing is so engaged, an interior chamber of the housing is placed in fluid communication with a tunnel defined by the temporary chute; and at least one sprinkler head located within the interior chamber of the housing, said at least one sprinkler head being adapted to deliver a volume of liquid into the tunnel of the temporary chute when actuated.

In one embodiment, the at least one sprinkler head may comprise a first sprinkler head provided in a first location within the interior chamber of the housing; and a second sprinkler head provided in a second location within the interior chamber of the housing. In one embodiment the first sprinkler head and the second sprinkler head may be separately actuated. In one embodiment, the first sprinkler head may be temperature sensitive and may be automatically actuated when a threshold temperature is reached within the interior chamber of the housing.

In one embodiment, the second sprinkler head may be manually actuated. In one embodiment, the sprinkler system may further comprise a switching mechanism which is operatively engaged with the second sprinkler head, and the switching mechanism may be operated to manually actuate the second sprinkler head. In one embodiment, the switching mechanism may include a fitting having a valve that is movable between an open position and a closed position, wherein the fitting is adapted to be connected to a remote liquid supply. In one embodiment, the liquid may be water but in other embodiments other suitable liquid may be provided to sprinkler system. The terms “water” and “liquid” as used herein should be understood to encompass any and all fluids that may be used to extinguish fires and/or control dust and/or wash out a temporary chute.

In one embodiment, the switching mechanism may further include a lever operatively engaged with the valve, and wherein the lever is hand operable to move the valve between the open position and the closed position. In one embodiment, the switching mechanism may further be operatively engaged with the first sprinkler head and may be interposed between the first sprinkler head and the second sprinkler head. In one embodiment, the hand lever may be movable between a first position and a second position and, when the hand lever is in the first position, liquid may be deliverable from the remote liquid supply to the first sprinkler head, and, when the hand lever is in the second position, liquid is deliverable from the remote liquid supply to the second sprinkler head.

In one embodiment, the sprinkler system may further comprise a fastener assembly provided on the housing and adapted to secure the housing to the temporary chute. In one embodiment, the housing may include a top wall; a peripheral wall extending downwardly from the top wall; and an annular flange extending radially outwardly from the peripheral wall a distance away from a lower end of the peripheral wall; and wherein the annular flange may be adapted to rest upon a top end of the temporary chute. In one embodiment a portion of the peripheral wall extends beneath the flange and is complementary to a cross-sectional shape of an upper region of the temporary chute.

In another aspect, an exemplary embodiment of the present disclosure may provide in combination, a temporary chute used for disposing of construction materials during a construction or renovation project, said temporary chute defining a tunnel which extends from an opening defined by an upper end of the temporary chute to a discharge opening defined by a lower end of the temporary chute; and a sprinkler system that is operatively engaged with the temporary chute proximate the upper end thereof, and wherein the sprinkler system is selectively actuated to deliver a volume of liquid into the tunnel of the temporary chute.

In one embodiment, the temporary chute may include an intake hopper which defines the upper end of the temporary chute; and wherein the sprinkler system may comprise a housing which is operatively engaged with the intake hopper; wherein the housing bounds and defines an interior chamber that is placed in fluid communication with the tunnel when the housing is engaged with the intake hopper. In one embodiment, the sprinkler system may further comprise at least one sprinkler head located within the interior chamber of the housing and adapted to be engaged with a remote liquid supply said at least one sprinkler head being adapted to deliver the volume of liquid into the tunnel of the temporary chute when actuated. In one embodiment, the at least one sprinkler head may comprise a first sprinkler head provided in a first location within the interior chamber; and a second sprinkler head provided in a second location within the interior chamber. In one embodiment, the first sprinkler head and the second sprinkler head may be separately actuated. In one embodiment, the first sprinkler head may be temperature sensitive and may be automatically actuated when a threshold temperature is reached within the interior chamber of the housing.

In one embodiment, the second sprinkler head used in the combination may be manually operable. In one embodiment, the sprinkler system of the combination may further comprise a switching mechanism interposed between the first sprinkler head and the second sprinkler head, wherein the switching mechanism may be movable between a first condition and a second condition, and when the switching mechanism is in the first condition, liquid may be deliverable from the remote liquid supply to the first sprinkler head, and when the switching mechanism is in the second condition, liquid may be deliverable from the remote liquid supply to the second sprinkler head.

In another aspect, and exemplary embodiment of the present disclosure may provide a method comprising installing a temporary chute for disposal of construction materials adjacent a wall of a building prior to a construction or renovation project; releasably engaging a sprinkler system with an upper end of the temporary chute; connecting the sprinkler system to a remote liquid supply; selectively delivering, with the sprinkler system, a volume of liquid into a tunnel defined by the temporary chute.

In one embodiment, the step of selectively delivering may further include extinguishing a fire within the tunnel of the temporary chute or below a discharge opening of the temporary chute. In one embodiment, the step of selectively delivering may further include spraying liquid into the tunnel and/or onto an interior surface of the temporary chute which defines the tunnel; and controlling dust within the tunnel or on the interior surface of the temporary chute which defines the tunnel. In one embodiment, the step of controlling of dust within the tunnel may further comprise conveying some or all of the dust out of the tunnel through a discharge opening of the temporary chute with the liquid sprayed into the tunnel and/or onto the interior surface of the temporary chute which defines the tunnel, i.e., washing the dust out of the temporary chute's discharge opening.

In one embodiment, the sprinkler system may include a housing that is releasably engageable with the upper end of the temporary chute and a first sprinkler head located within an interior chamber of the housing; and the method may further comprise monitoring a temperature in the interior chamber; and actuating the first sprinkler head when the temperature meets or exceeds a predetermined threshold temperature. In one embodiment, the sprinkler system may further comprise a second sprinkler head located within the interior chamber of the housing and a switching mechanism interposed between the first sprinkler head and the second sprinkler head, and the method may further comprise manually actuating the switching mechanism; and diverting liquid from the remote liquid supply from the first sprinkler head to the second sprinkler head. In one embodiment, the method may further comprise disengaging the sprinkler system from the temporary chute once the construction or renovation project is completed; dismantling the temporary chute; and transporting the temporary chute and the sprinkler system away from the building.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is right side elevation view of an upper region of a temporary chute located adjacent a sidewall of a building and showing a first embodiment of a sprinkler system in accordance with the present disclosure, where the sprinkler system is engaged with an intake hopper that forms an upper end of the temporary chute;

FIG. 2 is a rear elevation view of the upper region of the temporary chute and the sprinkler system of FIG. 1 shown in isolation away from the building;

FIG. 3 is an exploded rear elevation view of the upper region of the temporary chute and the sprinkler system shown in FIG. 2;

FIG. 4 is a top, front, right side elevation view of the sprinkler system in accordance with the present disclosure shown engaged with the intake hopper;

FIG. 5 is a top, front, right side elevation view of the sprinkler system shown in isolation and showing a first sprinkler head and a second sprinkler head disposed within an interior chamber of a housing of the sprinkler system;

FIG. 6 is a flow chart showing a method of using the sprinkler system in accordance with the present disclosure; and

FIG. 7 is a top, front, right side elevation view of a second embodiment of a sprinkler system in accordance with the present disclosure, wherein the second embodiment sprinkler system is configured to be engageable with an intake hopper that is of a square configuration.

Similar numbers refer to similar parts throughout the drawings.

### DETAILED DESCRIPTION

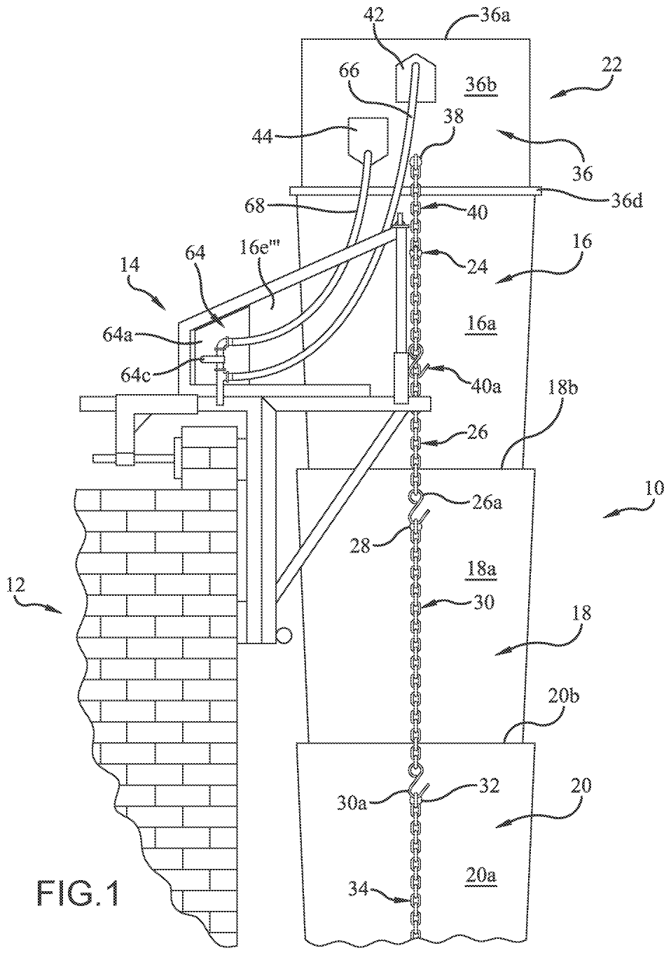

FIG. 1 shows a partial view of a temporary chute 10 for disposal of construction materials during a construction or renovation project. The chute 10 is temporarily mounted adjacent an inside or outside wall 12 of a building by way of a support frame/outrigger assembly 14 prior to the start of the construction or renovation project. During the project, construction materials to be discarded will be placed in the chute 10 and will travel therethrough to a receptacle below the lowermost end of the chute 10. When all construction materials to be discarded have been removed from the building, the temporary chute 10 is removed from the construction or renovation site.

The temporary chute 10 will now be described in greater detail with particular reference to FIG. 1. Chute 10 comprises an intake hopper 16 and a plurality of chute sections that are engaged with one another and extend downwardly from the intake hopper 16. The partial chute 10 illustrated in FIG. 1 includes a first chute section 18 and a second chute section 20. First chute section 18 is located vertically beneath intake hopper 16 and second chute section 20 is located vertically beneath first chute section 18. It will be understood that a number of additional chute sections may be located vertically beneath the second chute section 20. A terminal end of the chute 10 is located a distance vertically below intake hopper 16 and proximate the ground at a base of the building. The engagement of the plurality of chute sections with the intake hopper 16 will be further described later herein.

Support frame/outrigger assembly 14 may comprise any structure that is capable of supporting chute 10 and holding component parts of chute 10 adjacent the sidewall 12 of the building. The illustrated support frame/outrigger assembly 14 is located such that part of the structure cantilevers from the building and supports the intake hopper 16 a distance above an upper end of the sidewall 12. The outrigger 14 is arranged that the chute sections 18, 20 located vertically beneath intake hopper 16 are spaced a distance laterally outwardly from the sidewall 12. This arrangement helps to ensure that workers are easily able to load materials into the intake hopper 16 of chute 10 and that those materials deposited into the chute 10 will readily move through the chute 10 under the force of gravity.

It will be understood that any desired number of chute sections may be engaged beneath intake hopper 16 to form a chute 10 of any desired length. Intermediate intake hoppers (not shown) may be inserted between adjacent chute sections every so often in the chute to provide additional locations at which materials may be introduced into the chute 10. In many instances, a receptacle (not shown) may be positioned vertically beneath an opening in a lowermost chute section of chute 10. Materials deposited into intake hopper 16 and any additional intake hoppers will travel through chute 10 and be deposited into the receptacle if provided. Otherwise, materials moving through the chute 10 will simply drop on the ground located beneath the opening in the lowermost chute section. The manner in which intake hopper 16 and first and second chute sections 18, 20 are operatively engaged with one another will be described later herein.

Referring to FIGS. 1 through 5, a first embodiment of a sprinkler system in accordance with the present disclosure is engaged with intake hopper 16 and is generally indicated at 22. Sprinkler system 22 is contemplated to be a preassembled unit which an operator is able to quickly and easily engage with a temporary chute 10 used for disposing construction materials during construction or renovation projects. Sprinkler system 22 will be engaged with the temporary chute 10 prior to use of chute 10. The preassembled unit is also able to be quickly and easily disconnected and removed from the temporary chute 10 when the chute 10 is no longer needed. Sprinkler system 22 will be discussed in greater detail later herein.

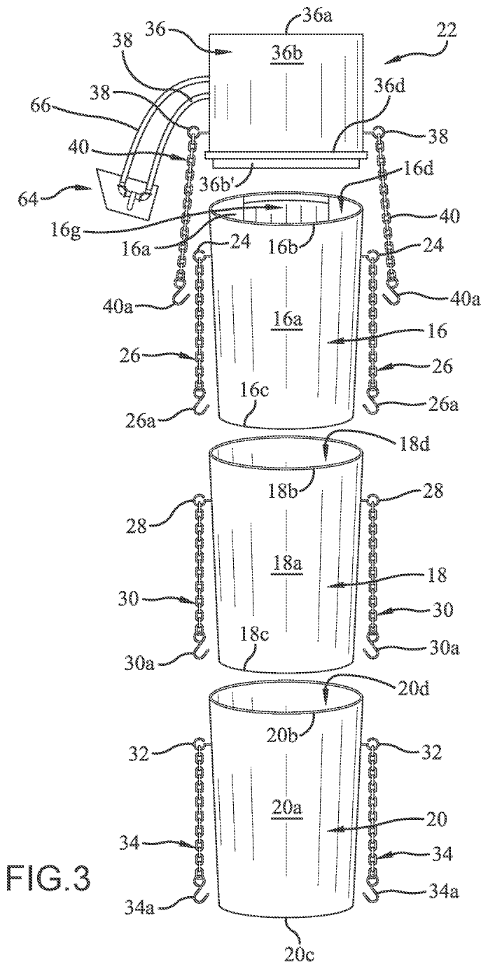

Chute 10, as illustrated, is generally cylindrical and is circular in cross-section. As such, intake hopper 16 is generally circular in cross-section as are first chute section 18 and second chute section 20. This is best seen in FIG. 3. Intake hopper 16 includes a sidewall 16a that is generally tubular in nature and tapers in diameter from a top end 16b to a bottom end 16c thereof. The sidewall 16a bounds and defines an interior cavity 16d which extends from an opening defined by top end 16b of intake hopper 16 to an opening (not shown) defined by bottom end 16c thereof.

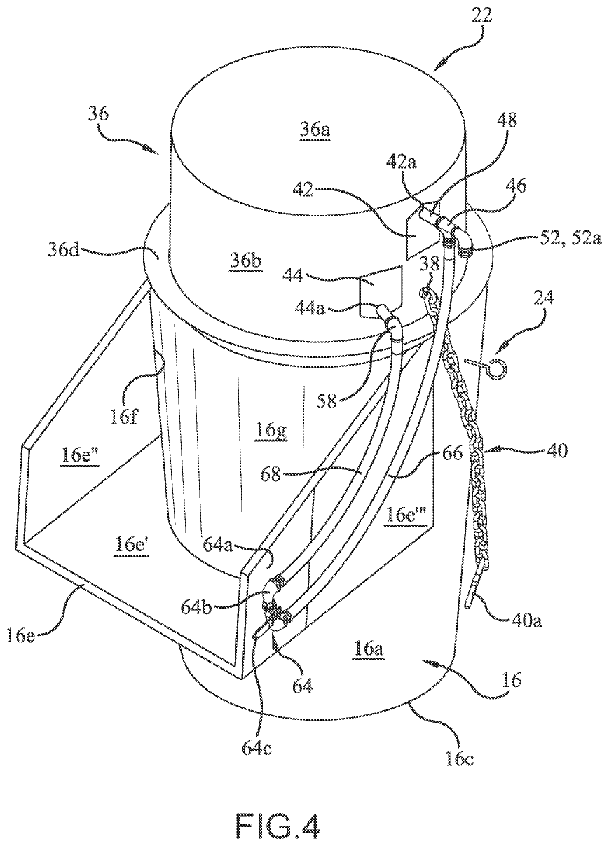

Referring to FIG. 4, an intake pan 16e is provided on intake hopper 16 and extends outwardly from a region of sidewall 16a. Intake pan 16e includes a bottom wall 16e′ and a pair of opposed sidewalls 16e″, 16e′″ that extend upwardly from bottom sidewall 16e′ and connect to sidewall 16a of intake hopper 16 at their innermost ends. An opening 16f is defined in the region of sidewall 16a of intake hopper 16 and a movable screen 16g hangs downwardly across opening 16f. Intake pan 16e provides ingress into interior cavity 16d through opening 16f. A lower end of screen 16g may be pushed inwardly into interior cavity 16d of intake hopper 16 as materials are moved along bottom wall 16e′ of intake pan 16e. Once the materials drop into interior cavity 16d, screen 16g will move back into its original position. Much of the dust created as materials travel through chute 10 will be prevented from blowing back out the opening 16f by screen 16g.

A pair of eyebolts 24 extends outwardly from regions of the sidewall 16a located on either side of intake pan 16e. Eyebolts 24 are located a distance downwardly from top end 16b of sidewall 16a and are positioned opposite one another about the circumference of sidewall 16a. A chain 26 hangs downwardly from each eyebolt 24 and extends for a distance above bottom end 16c of sidewall 16a. A hook 26a is provided at a free end of each chain 26 remote from the associated eyebolt 24.

Referring still to FIG. 3, first chute section 18 is also generally circular in cross-section and comprises a sidewall 18a which is generally tubular in nature and tapers in diameter from a top end 18b to a bottom end 18c thereof. The tubular sidewall 18a bounds and defines a cavity 18d which extends from an opening defined by top end 18b to an opening (not shown) defined by bottom end 18c. Sidewall 18a is substantially continuous and unbroken around its circumference. Eyebolts 28 are located a distance downwardly from top end 18b of sidewall 18a and are positioned opposite one another about the circumference of sidewall 18a. A chain 30 hangs downwardly from each eyebolt 28 and extends for a distance above bottom end 18c of sidewall 18a. A hook 30a is provided at a free end of each chain 30 remote from the associated eyebolt 28.

Referring still to FIG. 3, second chute section 20 is substantially identical to first chute section 18. As such, second chute section 20 is generally circular in cross-section and comprises a sidewall 20a which is generally tubular in nature and tapers in diameter from a top end 20b to a bottom end 20c thereof. The tubular sidewall 20a bounds and defines a cavity 20d which extends from an opening defined by top end 20b to an opening (not shown) defined by bottom end 20c. Sidewall 20a is substantially continuous and unbroken around its circumference. Eyebolts 32 are located a distance downwardly from top end 20b of sidewall 20a and are positioned opposite one another about the circumference of sidewall 20a. A chain 34 hangs downwardly from each eyebolt 32 and extends for a distance above bottom end 20c of sidewall 20a. A hook 34a is provided at a free end of each chain 34 remote from the associated eyebolt 32.

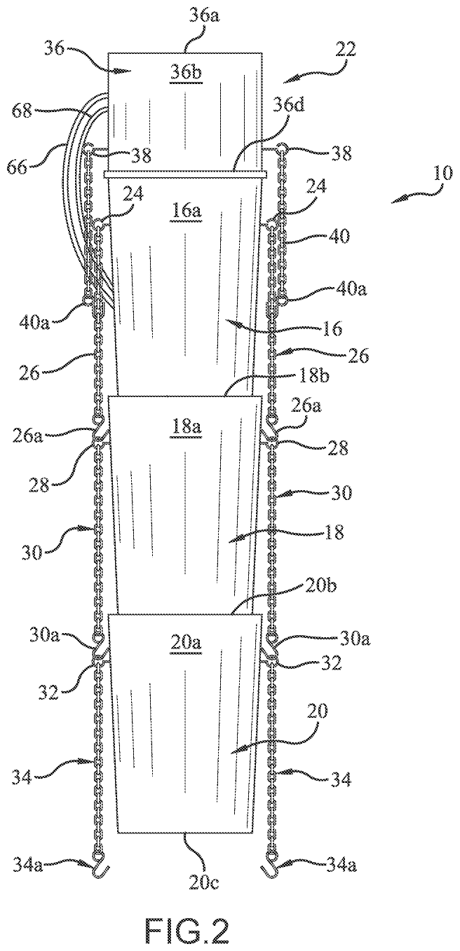

The intake hopper 16 and first and second chute sections 18, 20 of chute 10 are configured to nest one inside the other. As illustrated in FIGS. 1 and 2, a lower end region of intake hopper 16 is received within the cavity 18d defined by sidewall 18a of first chute section 18. Similarly, a lower end region of first chute section 18 is received within the cavity 20d defined by sidewall 20a of second chute section 20. Chains 26, 30, and 34 are utilized to secure intake hopper 16, first chute section 18 and second chute section 20 to one another. In particular, hooks 26a provided on chains 26 extending downwardly from intake hopper 16 are shown as being engaged with the eyebolts 28 on first chute section 18. Similarly, hooks 30a provided on chains 30 extending downwardly from first chute section 18 are engaged with eyebolts 32 on second chute section 20. Although not illustrated herein, the hooks 34a on chains 34 extending downwardly from second chute section 20 may be engaged with eyebolts on an additional chute section (not shown) within which second chute section 20 nests. It will be understood that a plurality of additional chute sections may be located beneath second chute section 20 and these additional chute sections may nest within one another and be engaged with one another in a similar manner to construct chute 10 of a desired length. The number of intake hoppers utilized in chute may be as few as one (at an upper end of the chute) or more than one if additional intermediate hoppers are also required to form a chute 10 that is safe to operate.

The tapered shape of the intake hopper 16 and first and second chute sections 18, 20 will automatically limit an overall minimum length of the chute 10 because a higher chute section e.g. intake hopper 16 is able to move downwardly into cavity 18d of the first chute section 18 until an exterior diameter of intake hopper 16 is substantially identical to the interior diameter of first chute section 18. Similarly, first chute section 18 is able to move downwardly into cavity 20d of second chute section 20. The overall length of chute 10 may be increased or decreased by selectively engaging the hooks at the ends of the chains 26, 30, 34 with an eyebolt of a lower chute section or with a link of the chain of the lower chute section.

When the chute sections are nested and linked together by the chains as described above, the interior cavities 16d, 18d, and 20d of the intake hopper 16, first chute section 18, and second chute section 20 will be placed in fluid communication with one another and form a tunnel that extends from the top end 16b of intake hopper 16 to a bottom end 20c of the second chute section 20. Materials deposited into the cavity 16d of intake hopper 16 through intake pan 16e will drop down the tunnel formed by the cavities 16d, 18d, and 20d. If additional chute sections form part of chute 10, then the deposited materials will ultimately drop out through an opening defined by a lowermost chute section in the chute 10, and into a receptacle if provided.

One of the problems with chutes used to dispose of construction materials such as chute 10, is that clouds of dust are created as the materials drop through the tunnel of the chute 10 and out into the receptacle below the chute 10. The dust can blow back up the chute tunnel and out of the top end 16b of intake hopper 16, or out of the screened opening 16f of the intake hopper, or out of the openings defined in intermediate hoppers, if provided in chute 10. Another problem experienced with such chutes 10 is that, from time to time, fires can break out in the receptacle located beneath the opening defined in the lowermost chute section of chute 10. In this instance, the chute 10 may act as a chimney and suck air into the tunnel from the opening defined by top end 16b of intake hopper or through the opening 16f, or through openings in intermediate hoppers (if provided), or through the opening defined in the bottom end of the lowermost chute section of the chute.

Sprinkler system 22 and a method of use thereof in accordance with an aspect of the present disclosure are disclosed herein as providing an apparatus and a method for controlling dust within chute 10 and within a receptacle located beneath chute 10. Sprinkler system 22 and the method of using the same also provide an apparatus and method for extinguishing fires within chute 10 and/or within a receptacle located beneath chute 10.

Sprinkler system 22 is fabricated to be complementary to chute 10 and is particularly fabricated to be complementary to intake hopper 16. Sprinkler system 22 includes a housing 36 which is configured to be seated in engagement with top end 16b of intake hopper 16 and to close off access to interior cavity 16d via the opening defined by top end 16b. Housing 36 may be fabricated from any suitable material including, but not limited to aluminum, aluminized steel, galvanized steel, galvanneal steel, and stainless steel. Housing 36 comprises a top wall 36a and a peripheral wall 36b extending downwardly from top wall 36a. Peripheral wall 36b terminates in a lower end 36c. An annular flange 36d extends radially outwardly from an exterior surface 36b a distance away from lower end 36c moving in a direction towards top wall 36a. An annular region 36b′ of peripheral wall is therefore located below flange 36d.

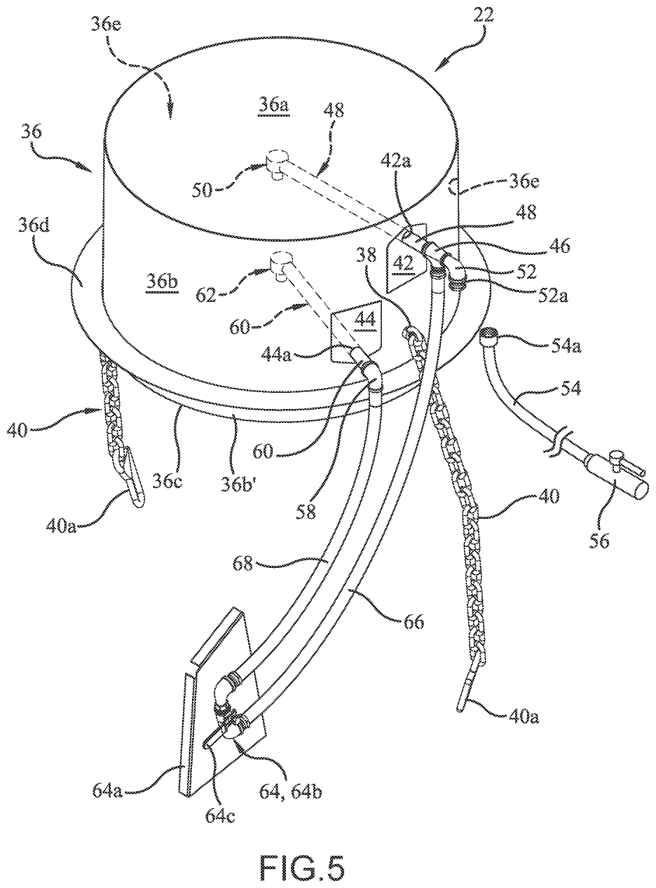

In accordance with an aspect of the present disclosure, peripheral wall 36b, and particularly, annular region 36b′ of peripheral wall 36 is complementary in size and shape to the opening defined by top end 16b of intake hopper 16. Annular region 36b′ is of an exterior shape and diameter that is able to be received within interior cavity 16d of intake hopper 16. In one embodiment, annular region 36b′ is complementary in shape and size to an interior diameter of an upper region of sidewall 16a of intake hopper 16. Annular flange 36d is of a greater diameter than the opening defined by top end 16b of sidewall 16b of intake hopper 16. When housing 36 is engaged with intake hopper 16, annular region 36b′ of housing 36 is received through the opening defined by top end 16a of intake hopper 16 and extends for a distance downwardly into interior cavity 16d. Annular flange 36d rests in abutting contact on top end 16b of intake hopper 16. Annular flange 36d extends outwardly for a distance beyond the sidewall 16a of intake hopper 16. Because chute 10 is cylindrical in shape, peripheral wall 36b of housing 36 (or at least annular region 36b′ of peripheral wall 36b) is circular in cross-section. As illustrated in FIG. 5, in one embodiment top wall 22a is also circular in shape when viewed from above. It will be understood, however, that the configuration of housing 36 above annular flange 36d may be of any desired shape and size.

A fastener assembly is provided for securing housing 36 to chute 10. As illustrated herein the fastener assembly includes a pair of eyebolts 38 which are secured in opposing regions of peripheral wall 36b of housing 36. The fastener assembly also includes a pair of chains 40, with each chain 40 being operatively engaged with one of the two eyebolts 38. Chains 40 hang downwardly from peripheral wall 36b and beyond lower end 36c of housing 36. A hook 40a is provided at an end of each chain 40. When sprinkler system 22 is engaged with intake hopper 16, region 36b′ of peripheral wall 36b is received in interior cavity 16d of intake hopper 16 and flange 36d rests upon top end 16a of intake hopper 16. The chains 40 extend downwardly for a distance along the exterior surface of intake hopper's sidewall 16a and the hooks 40 are connected to a lowest possible link on the chains 28 extending downwardly from intake hopper 16. The chains 40 are connected to the lowest possible link on chains 28 so that sprinkler system 22 is held in secure engagement with intake hopper 16 and the opening defined by top end 16b of intake hopper 16 is effectively sealed. This arrangement helps to ensure that if the sprinkler system 22 and chute 10 are subjected to high winds or other forces, sprinkler system 22 will remain engaged with intake hopper 16.

It will be understood that in other embodiments only one eyebolt 38 and one chain 40 may be utilized. It will further be understood that in other embodiments more than two eyebolts 38 and a complementary number of chains 40 may be utilized to secure housing 36 to chute 10. It will further be understood that in other embodiments a completely different type of fastener may be used to secure housing 36 and chute 10 to one another. For example, some type of clamping mechanism may be utilized.

Referring to FIG. 5, top wall 36a and peripheral wall 36b of housing 36 bound and define an interior chamber 36e that is placed in fluid communication with interior cavity 16d of intake hopper 16 when sprinkler system 22 is engaged with intake hopper 16. Interior chamber 36e is placed in fluid communication with interior cavity 16d via an opening bounded and defined by lower end 36c of peripheral wall 36b. Housing 36 therefore effectively becomes an extension of intake hopper 16.

Referring to FIG. 5, a first mounting plate 42 and a second mounting plate 44 are secured in any suitable manner to the exterior surface of peripheral wall 36b. First mounting plate 42 defines a first hole 42a therein and second mounting plate 44 defines a second hole 44a therein. A first aperture (not shown) is defined in peripheral wall 36b of housing 36 and is located to align with the first hole 42a defined in first mounting plate 42. A second aperture (not shown) is defined in peripheral wall 36b of housing 36 and is located to align with the second hole 44a defined in second mounting plate 44. Each of the first aperture and second aperture extends between an exterior surface of the peripheral wall 36b and an interior surface thereof. The first aperture is located a distance vertically above the second aperture and the first and second apertures are laterally spaced a distance away from one another.

Referring still to FIG. 5, sprinkler system 22 further includes a first inlet fitting 46. In the illustrated embodiment, first inlet fitting 46 is a tee-connector. A first pipe 48 is engaged with first inlet fitting 46 and first pipe 48 extends through the opening 42a defined in first mounting plate 42 and through the associated first aperture defined in peripheral wall 36b. First pipe 48 extends for a distance into interior chamber 36e of housing 36 and a first sprinkler head 50 is engaged with a free end of first pipe 48. First sprinkler head 50 is of a type that is temperature-sensitive and is configured to monitor air temperature within the interior chamber 36e of housing. First sprinkler head 50 is configured to automatically activate when a predetermined or preset temperature threshold is crossed. Any suitable mechanism for monitoring temperature and activating first sprinkler head 50 may be utilized. For example, first sprinkler head 50 may include a temperature sensitive fuse which ruptures when the threshold temperature is reached or crossed, thereby activating the flow of water (or another fire extinguishing liquid) from first sprinkler head.

The temperature within the interior chamber 36e of housing 36 may become elevated if a fire occurs within any part of the tunnel defined by chute 10 or on the ground beneath the chute or in a receptacle located below a discharge opening defined in a bottom end of chute 10. (In the chute illustrated in FIGS. 1-3, second chute section 20 may be the lowest chute section in chute 10 and the opening defined by bottom end 20c thereof will then be the chute's discharge opening.) When water has been dispensed from first sprinkler head 50 and the fire which caused the elevated temperature has been extinguished, the operator manually deactivates first sprinkler head 50.

First sprinkler head 50 is located generally centrally within an upper region of the interior chamber 36e defined by housing 36 and is configured to spray liquid radially outwardly therefrom. In one embodiment, first sprinkler head 50 is configured to spray liquid one or both of radially outwardly towards the interior surface of peripheral wall 36b of housing 36 and downwardly into interior chamber 36e thereof. As a consequence, first sprinkler head 50 also sprays liquids downwardly and outwardly towards the interior surface of an upper region of intake hopper 16 and into interior cavity 16d defined by sidewall 16a of intake hopper 16. In one embodiment, first sprinkler head 50 is of a type that is automatically activated when a predetermined or preset threshold temperature is reached within interior chamber 36e. In one embodiment, first sprinkler head 50 is activated when a threshold temperature of about 165° F. is reached within interior chamber 36e.

An elbow 52 is engaged with the tee-connector that is first inlet fitting 46. Elbow 52 includes an end region 52a configured to permit attachment of a water hose 54 to sprinkler system 22. Water hose 54 has a connector 54a at one end that is complementary to the end region 52a of elbow 52. A second end of the water hose 54 is connected to a remote water supply 56. Water hose 54 may be a standard ¾″ water hose which provides water from the remote water supply 56 to sprinkler system 22 at a minimum pressure of 60 psi.

Referring still to FIG. 5, sprinkler system 22 further includes a second inlet fitting 58 with which a second pipe 60 is operatively engaged. Second pipe 60 extends through the opening 44a defined in second mounting plate 44 and through the associated second aperture defined in peripheral wall 36b. Second pipe 60 extends for a distance into interior chamber 36e of housing 36 and a second sprinkler head 62 is engaged with a free end of second pipe 60. Second sprinkler head 62 is located generally centrally within an upper region of the interior chamber 36e defined by housing 36 but a distance vertically below first sprinkler head 50. Second sprinkler head 62 may be offset relative to first sprinkler head 50.

In accordance with a further aspect of the present disclosure, a switching mechanism 64 interposed between the first sprinkler head 50 and the second sprinkler head 62. Switching mechanism 64 is operatively engaged with intake pan 16e of intake hopper 16, and thereby with chute 10. In particular, switching mechanism 64 includes at least one mounting plate 64a that is secured to side wall 16e′″ of intake pan 16e by any suitable means. Switching mechanism 64 further includes a fitting 64b which includes a valve therein that is movable between an open position and a closed position. The valve may be of any suitable type. In one embodiment, the valve is a ball valve which is moved between the open position and the closed position by a manually operated hand lever 64c. In one embodiment, the ball valve is a spring-loaded ball valve.

A first connector hose 66 extends between one end of the fitting 64b and the tee-connector that is first inlet fitting 46. A second connector hose 68 extends between the other end of the fitting 64b and the second inlet fitting 58.

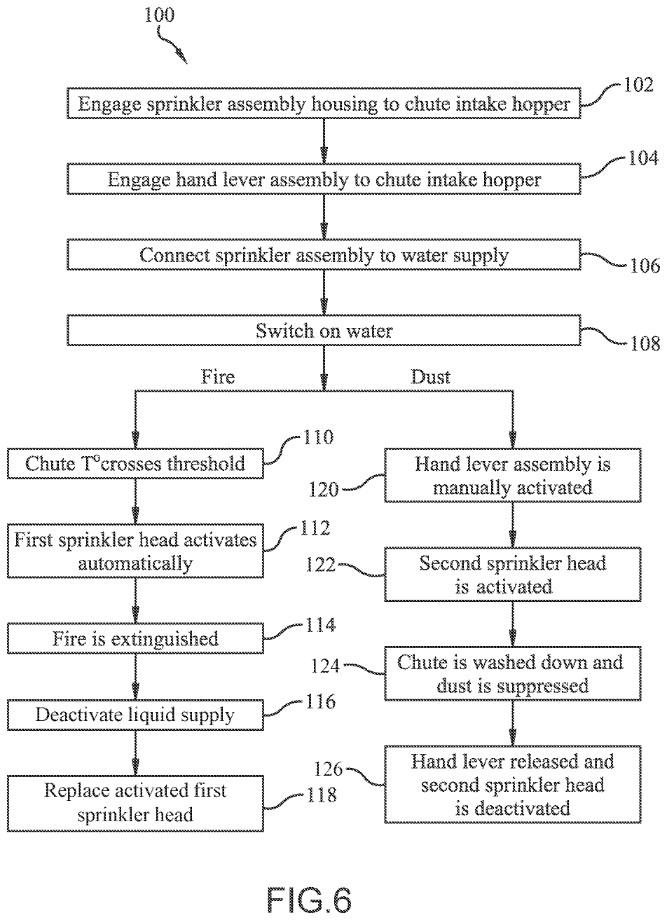

A method of using sprinkler system 22 is illustrated in the block diagram of FIG. 6 and is described hereafter. The method is generally indicated by the reference character 100. In a first step, indicated at 102, sprinkler system 22 is engaged with intake hopper 16. This first step 102 is accomplished by positioning sprinkler system 22 over the opening defined by top end 16b of intake hopper 16, inserting the region 36b′ of the housing 36 of sprinkler system into the opening defined by top end 16b, abutting the flange 36d of housing 36 against top end 16b of intake hopper 16. As part of first step 102, chains 40 that extend downwardly from housing 36 are aligned with chains 26 extending downwardly from intake hopper 16. Chains 40 are extended to their maximum length and the hook 40a of each sprinkler system chain 40 is engaged with a lowest possible link of the associated intake hopper chain 26. At this point, sprinkler system 22 is operatively engaged with intake hopper 16 and the interior chamber 36d of housing 36 is in fluid communication with interior cavity 16d of intake hopper 16.

In a second step 104, the switching mechanism 64 (i.e., the hand lever assembly) of sprinkler system 22 is engaged with the intake pan 16e of intake hopper 16.

In a third step 106, the water hose 54 is connected to the elbow 52 engaged with the tee-connector of first inlet fitting 46. This is accomplished by engaging the connector 54a of the water hose 54 with the end 52a of the elbow 52. A second end of the water hose 54 is operatively engaged with the remote water supply 56.

In a fourth step 108, the remote water supply 56 is turned on. As indicated earlier herein, ideally, the remote water supply 56 should provide water at a pressure of at least 60 psi. Once the water supply 54 is turned on, sprinkler system 22 is ready for use.

In a fifth step 110, if a fire occurs within chute 10 or within a receptacle located beneath chute 10, the temperature within the tunnel defined by chute 10 will rise. If the temperature within interior chamber 36e of housing 36 of sprinkler system 22 reaches a threshold temperature or higher (such as a threshold of 165° F.), then the first sprinkler head 50 will automatically activate, as indicated in step six 112, and spray water into the interior chamber 36e and thereby into the tunnel defined by chute 10. Water will continue to be sprayed from first sprinkler head 50 until the fire is extinguished as at 114. Once the fire is extinguished, the operator will manually deactivate the remote water supply (step 116). The activated, temperature sensitive, first sprinkler head 50 is then replaced in sprinkler system 22. The reason this replacement is needful is because the temperature sensitive fuse in first sprinkler head 50 is damaged or destroyed when the first sprinkler head is activated. The replacement of the activated first sprinkler head 50 is indicated at 118 in FIG. 6.

Alternatively, the operator may decide that too much dust is being generated by disposing of materials through chute 10 or that the job is completed and the operator wishes to wash down the interior of the chute 10. In this instance, indicated as step 120 in the method 100 (FIG. 6), the operator will manually pull down or push down the hand lever 64c of switching mechanism 64. This manual movement of the hand lever 64c will activate the second sprinkler head 62 as at 122 in FIG. 6. The actuation of second sprinkler head 62 includes that the pulling down or pushing down of the hand lever 64c will open a ball valve within hand lever fitting 64b. Water from the water hose 54 will flow through the tee-connector 46 down the first connector hose 66, through the fitting 64b of switching mechanism 64, and to the second connector hose 68. The water will subsequently flow through the second pipe 60 and be sprayed out of the second sprinkler head 62 into the interior chamber 36e of housing 36 and thereby into the tunnel defined by chute 10. Water sprayed by second sprinkler head 62 will wash down the interior surface of chute 10 that defines the tunnel. This wash down operation is indicated as step 124 in FIG. 6. The wash down of the chute 10 can be undertaken as often as the operator deems necessary. When the operator is satisfied with the wash down, the hand lever 64c is moved to deactivate the second sprinkler head 62. The step of deactivating the second sprinkler head 62 is indicated at 126 in FIG. 6. In one embodiment, hand lever 64c may be spring-loaded and will automatically move the hand lever 64c from an on position to an off position when the hand lever is released by the operator. In one embodiment, when the operator stops pulling down or pushing down the hand lever 64c, the spring-loaded ball valve within fitting 64b will return to its original position and the valve will close, cutting off water to second sprinkler head 62. In another embodiment, the operator may physically move the hand lever 64c from the on position to the off position to deactivate the second sprinkler head 62.

Typically, the hand lever 64c will not be manually operated to wash down the interior surfaces of the intake hopper 16 and chute 10 if a fire is actively burning within the chute 10 or in the receptacle below the chute 10. While hand lever 64c is depressed, water from remote water supply 56 will be diverted away from the first sprinkler head 50 and will instead be delivered by second connector hose 68 to the second sprinkler head 62 via the second inlet fitting 58 as indicated by the step 122 in FIG. 6. Obviously, if the operator determines a fire has started to burn within chute 10 or within the receptacle beneath chute 10, the operator can manually operate second sprinkler head 50 to spray a volume of water into the chute 10. The operator may therefore take remedial action before the fire gets out of hand and the threshold temperature for the first sprinkler head 50 is reached and the sprinkler 50 is activated.

When chute 10 is no longer needed, sprinkler system 22 will be disengaged from intake hopper 16. In a first disengaging step, water hose 54 is disengaged from the remote water supply 56. Once the water supply 56 is disconnected from sprinkler system 22, both sprinkler heads 50, 62 will become inactive. The preassembled unit of the sprinkler system 22 (shown in FIG. 5) will then be detached from the temporary chute 10 by disengaging the hooks 40a on chains 40 from the chains 26 of intake hopper 16. The preassembled unit of sprinkler system 22 will then be lifted off the upper end of intake hopper 16. The temporary chute 10 will then be disassembled by reversing the steps previously described herein. The various components of chute 10 and sprinkler system 22 will be moved to a new worksite.

In summary, a method in accordance with the present disclosure may comprise installing a temporary chute 10 for disposal of construction materials adjacent a wall 12 of a building prior to a construction or renovation project; engaging a sprinkler system 22 with an upper end of the temporary chute 10. The upper end of chute 10 as disclosed herein is the upper end of the intake hopper 16 which includes top end 16b. The method further includes releasably engaging the sprinkler system 22 with the temporary chute 10. The method further comprises connecting the sprinkler system 22 to a remote water supply 56 (FIG. 5); and selectively delivering, with the sprinkler system 22, a volume of water into a tunnel defined by the chute 10. The tunnel with respect to the attached drawings comprises the interior cavities 16d, 18d, and 20d of the intake hopper 16 and first and second chute sections 18, 20. The step of selectively delivering the volume of water will result in a fire within the tunnel 16d, 18d, 20d of the chute 10 or below a discharge opening of the tunnel being extinguished. (In the attached figures, the discharge opening will be the opening defined by the bottom end 20c of the second chute section 20.

The step of selectively delivering the volume of water may include spraying water into the tunnel 16d, 18d, 20d and/or onto an interior surface of the chute 10 which defines the tunnel 16d, 18d, 20d. The step of selectively delivering the volume of water may result in controlling dust within the tunnel 16d, 18d, 20d or on the interior surface of the chute 10 which defines the tunnel (or below the discharge opening to the tunnel 16d, 18d, 20d). The step of controlling of dust within the tunnel 16d, 18d, 20d may further include conveying some or all of the dust out of the tunnel 16d, 18d, 20d through a discharge opening of the temporary chute 10 with the water sprayed into the tunnel and/or onto the interior surface of the temporary chute 10 which defines the tunnel, i.e., washing the dust out of the chute's discharge opening.

The sprinkler system includes a housing 36 that is engageable with the upper end of the chute 10 and a first sprinkler head 50 located within an interior chamber 36e of the housing 36; and the method of using the sprinkler system 22 may further comprise monitoring a temperature in the interior chamber 36e; and actuating the first sprinkler head 50 when the temperature meets or exceeds a predetermined threshold temperature (such as 165° F.). The sprinkler system further comprises a second sprinkler head 62 located within the interior chamber 36e of the housing 36 and a switching mechanism 64 (and first and second connector hoses 66, 68) interposed between the first sprinkler head 50 and the second sprinkler head 62. The method further comprises manually actuating the switching mechanism 64 from a first condition to a second condition, and diverting water from the remote water supply 56 from the first sprinkler head 50 to the second sprinkler head 62. When the switching mechanism 64 is released, the switching mechanism 64 will move back from the second condition to the first condition, and water from the remote water supply 56 will once again be available to the first sprinkler head 50 but not to the second sprinkler head 62. The switching mechanism 64 includes a valve (within fitting 64b) that is movable between a first position and a second position under hand pressure from an operator. In particular, when a hand lever 64c of the switching mechanism is contacted by the operator, the valve will move from the first position to the second position and water will be able to flow to the second sprinkler head 62 from the remote water source 56. When the hand lever 64c is released, the valve within the fitting 64b automatically returns to its original position, i.e., the first position (since the valve is biased into the first position to ensure what is always available to automatically extinguish a fire).

The method will further include disengaging the sprinkler system 22 from the temporary chute 10 once the construction or renovation project is completed, dismantling the temporary chute 10, and transporting the temporary chute 10 and sprinkler system 22 away from the constructed or renovated building.

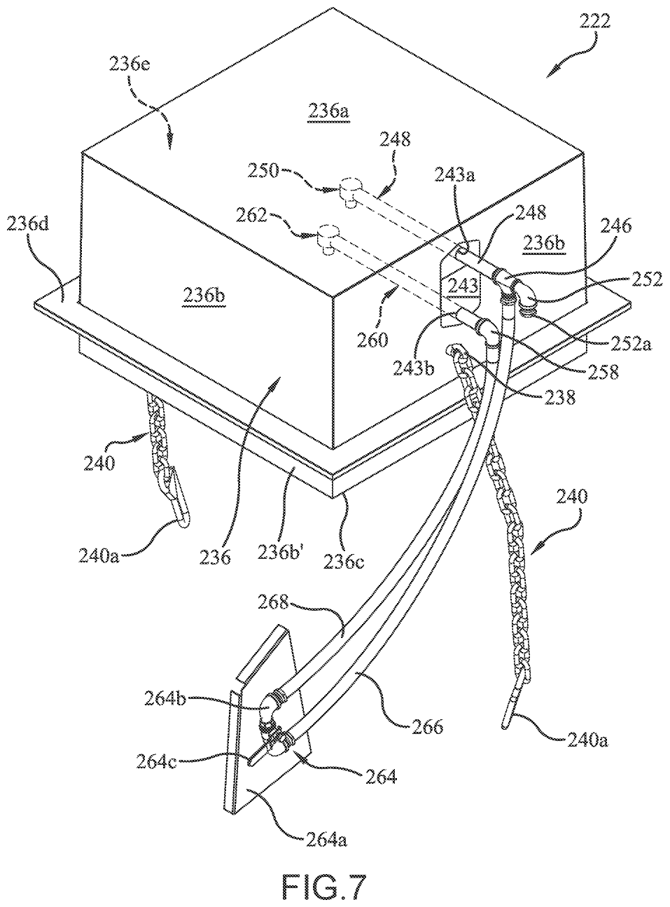

Referring now to FIG. 7, there is shown a second embodiment of a sprinkler system in accordance with the present disclosure, generally indicated at 222. Sprinkler system 222 is substantially identical to sprinkler system 22 in all aspects except for the configuration of the housing. Sprinkler system 222 includes a housing 236 which is substantially square when viewed from above or and is configured for engagement with a chute (not shown) that is of a generally square cross-section. Sprinkler system 22, by contrast, is generally circular in cross-section and is configured for engagement with a chute that is generally circular in cross-section. Housing 236 includes a top wall 236a that is square when viewed from above. A peripheral wall 236b extends downwardly from the square perimeter of top wall 236a and terminates in a lower edge 236c. A flange 236d extends outwardly away from peripheral wall 236b and is oriented generally orthogonally relative thereto. A lower region 236b′ of peripheral wall 236b extends for a distance downwardly below flange 236d, terminating in lower edge 236c. Lower region 236b′ is configured to be received inside an interior cavity of an intake hopper (not shown) that is complementary in shape and size to lower region 236b′. An underside of flange 236d will rest on a top end of the intake hopper. Housing 236 bounds and defines an interior chamber 236e that is substantially similar in function to interior chamber 36e of sprinkler system 22. A plurality of chute sections will be engaged with intake hopper as previous described herein with respect to chute 10 and when housing 236 is engaged with the intake hopper, the interior chamber 236e of housing 236 will be in fluid communication with the tunnel defined by the chute.

Sprinkler system 222 includes a pair of eyebolts 238 that are engaged in opposed side surfaces of peripheral wall 236b. A chain 240 is engaged with each eyebolt 238 and chains 240 extend downwardly for a distance beyond lower end 236c of the lower region 236b′ of peripheral wall 236b. Each chain 240 terminates in a hook 240a. Eyebolts 238, chains 240, and hooks 240a are substantially identical to and are utilized for the same function as eyebolts 38, chains 40, and hooks 40a of sprinkler system 22.

A single mounting plate 243 is operatively engaged with one of the side surfaces of peripheral wall 236b. Mounting plate 243 defines a first hole 243a and a second hole 243b therein. First hole 243a is located a distance vertically above second hole 243b. First hole 243a is configured and located to be aligned with a first aperture (not shown) defined in the side surface of peripheral wall 236b. Second hole 243b is configured and located to be aligned with a second aperture (not shown) defined in the side surface of peripheral wall 236b a distance vertically below the first aperture. Sprinkler system 222 further comprises a first inlet fitting 246, a first pipe 248, and a first sprinkler head 250 which are all substantially identical in structure, function and operation to first inlet fitting 46, first pipe 48, and first sprinkler head 50 of sprinkler system 22.

First inlet fitting 246 also includes an elbow 252 having threads 252a thereon which are suitable for connecting engagement of a water hose thereto. Inlet fitting 246, the elbow 252, and the threads 252a are all substantially identical in structure, function, and operation to first inlet fitting 56, elbow 52, and threads 52a of sprinkler system 22. Although not illustrated in FIG. 7, it will be understood that a connector of a water hose similar to connector 54a and water hose 54 (FIG. 5) may be engaged with threads 252a on elbow to connect sprinkler system 222 to a remote water supply. In other instances quick-connect fittings may be provided on elbow 252 and the water hose in place of the threaded regions.

A switching mechanism 264, a first connector hose 266, and a second connector hose 268 are operatively engaged with an intake pan of an intake hopper of a chute that is of a square cross-section. Switching mechanism 264, first and second connector hoses 266, 268 are all substantially identical in structure, function, and operation to switching mechanism 64, first connector hose 66 and second connector hose 68 of sprinkler system 22.

Still referring to FIG. 7, a second inlet fitting 258, a second pipe 260 and a second sprinkler head 262 are all part of sprinkler system 222. Second inlet fitting 258, second pipe 260, and second sprinkler head 262 are all substantially identical in structure, function, and operation to second inlet fitting 58, second pipe 60, and second sprinkler head 62 of sprinkler system 22. Because the first hole 243a in mounting plate 243 and the associated first aperture in the peripheral wall 236b of housing 236 are located vertically above the second hole 243b and associated second aperture in the peripheral wall 236b, second sprinkler head 262 will be located vertically beneath first sprinkler head 250.

It will be understood that sprinkler system 222 will be engaged with an intake hopper of a temporary chute in substantially the same manner as disclosed with respect to the engagement of sprinkler system 22 with intake hopper 16 of chute 10. Furthermore, sprinkler system 222 will function in substantially an identical manner to sprinkler system 22 and as illustrated in FIG. 6. Finally, sprinkler system 222 will be disengaged from the intake hopper of the temporary chute in substantially the same manner that sprinkler system 22 is disengaged from intake hopper 16 of chute 10.

While the sprinkler systems disclosed herein have been discussed as being engageable with a temporary chute for the disposal of construction materials, it will be understood that in other instances the disclosed sprinkler systems may be installed on a permanent chute and remain in place after installation.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A sprinkler system for a temporary chute used for disposing of construction materials during a construction or renovation project, said sprinkler system comprising:
a housing adapted to be releasably operatively engaged with the temporary chute and, when the housing is so engaged, an interior chamber of the housing is placed in fluid communication with a tunnel defined by the temporary chute; and
at least one sprinkler head located within the interior chamber of the housing, said at least one sprinkler head being adapted to deliver a volume of liquid into the tunnel of the temporary chute when actuated.

2. The sprinkler system according to claim 1, wherein the at least one sprinkler head comprises:
a first sprinkler head provided in a first location within the interior chamber of the housing; and
a second sprinkler head provided in a second location within the interior chamber of the housing.

3. The sprinkler system according to claim 2, wherein the first sprinkler head and the second sprinkler head are separately actuated.

4. The sprinkler system according to claim 2, wherein the first sprinkler head is temperature sensitive and is automatically actuated when a threshold temperature is reached within the interior chamber of the housing.

5. The sprinkler system according to claim 2, wherein the second sprinkler head is manually actuated.

6. The sprinkler system according to claim 2, further comprises a switching mechanism which is operatively engaged with the second sprinkler head, and wherein the switching mechanism is operated to manually actuate the second sprinkler head.

7. The sprinkler system according to claim 6, wherein the switching mechanism includes:
a fitting having a valve that is movable between an open position and a closed position, wherein the fitting is adapted to be connected to a remote liquid supply.

8. The sprinkler system according to claim 7, wherein the switching mechanism further includes:
a lever operatively engaged with the valve, and wherein the lever is hand operable to move the valve between the open position and the closed position.

9. The sprinkler system according to claim 8, wherein the switching mechanism is further operatively engaged with the first sprinkler head and is interposed between the first sprinkler head and the second sprinkler head.

10. The sprinkler system according to claim 9, wherein the hand lever is movable between a first position and a second position, and when the hand lever is in the first position, liquid is deliverable from the remote liquid supply to the first sprinkler head, and when the hand lever is in the second position, liquid is deliverable from the remote liquid supply to the second sprinkler head.

11. The sprinkler system according to claim 1, further comprising:
a fastener assembly provided on the housing and adapted to secure the housing to the temporary chute.

12. The sprinkler system according to claim 1, wherein the housing includes:
a top wall;
a peripheral wall extending downwardly from the top wall; and an annular flange extending radially outwardly from the peripheral wall a distance away from a lower end of the peripheral wall; and wherein the annular flange is adapted to rest upon a top end of the temporary chute.

13. In combination:
a temporary chute used for disposing of construction materials during a construction or renovation project, said temporary chute defining a tunnel which extends from an opening defined by an upper end of the temporary chute to a discharge opening defined by a lower end of the temporary chute; and
a sprinkler system that is operatively engaged with the temporary chute proximate the upper end thereof, and wherein the sprinkler system is selectively actuated to deliver a volume of liquid into the tunnel of the temporary chute.

14. The combination according to claim 13, wherein the temporary chute includes an intake hopper which defines the upper end of the temporary chute; and wherein the sprinkler system comprises:
a housing which is operatively engaged with the intake hopper; wherein the housing bounds and defines an interior chamber that is placed in fluid communication with the tunnel when the housing is engaged with the intake hopper.

15. The combination according to claim 14, wherein the sprinkler system further comprises:
at least one sprinkler head located within the interior chamber of the housing and adapted to be engaged with a remote liquid supply said at least one sprinkler head being adapted to deliver the volume of liquid into the tunnel of the temporary chute when actuated.

16. The combination according to claim 15, wherein the at least one sprinkler head comprises:
a first sprinkler head provided in a first location within the interior chamber; and
a second sprinkler head provided in a second location within the interior chamber.

17. The combination according to claim 16, wherein the first sprinkler head and the second sprinkler head are separately actuated.

18. The combination according to claim 16, wherein the first sprinkler head is temperature sensitive and is automatically actuated when a threshold temperature is reached within the interior chamber of the housing.

19. The combination according to claim 16, wherein the second sprinkler head is manually operable.

20. The combination according to claim 16, wherein the sprinkler system further comprises a switching mechanism interposed between the first sprinkler head and the second sprinkler head, wherein the switching mechanism is movable between a first condition and a second condition, and when the switching mechanism is in the first condition, liquid is deliverable from the remote liquid supply to the first sprinkler head, and when the switching mechanism is in the second condition, liquid is deliverable from the remote liquid supply to the second sprinkler head.

21. A method comprising:
installing a temporary chute for disposal of construction materials adjacent a wall of a building prior to a construction or renovation project;
releasably engaging a sprinkler system with an upper end of the temporary chute;
connecting the sprinkler system to a remote liquid supply;
selectively delivering, with the sprinkler system, a volume of liquid into a tunnel defined by the temporary chute.

22. The method according to claim 21, wherein the selectively delivering further includes:
extinguishing a fire within the tunnel of the temporary chute or below a discharge opening of the temporary chute.

23. The method according to claim 21, wherein the selectively delivering further includes:
spraying liquid into the tunnel and/or onto an interior surface of the temporary chute which defines the tunnel; and
controlling dust within the tunnel or on the interior surface of the temporary chute which defines the tunnel.

24. The method according to claim 23, wherein the controlling of dust within the tunnel further comprises:
conveying some or all of the dust out of the tunnel through a discharge opening of the temporary chute with the liquid sprayed into the tunnel and/or onto the interior surface of the temporary chute which defines the tunnel.

25. The method according to claim 21, wherein the sprinkler system includes a housing that is engageable with the upper end of the temporary chute and a first sprinkler head located within an interior chamber of the housing; and wherein the method further comprises:
monitoring temperature in the interior chamber;
actuating the first sprinkler head when the temperature meets or exceeds a predetermined threshold temperature.

26. The method according to claim 25, wherein the sprinkler system further comprises a second sprinkler head located within the interior chamber of the housing and a switching mechanism interposed between the first sprinkler head and the second sprinkler head, and wherein the method further comprises:
manually actuating the switching mechanism; and
diverting liquid from the remote liquid supply from the first sprinkler head to the second sprinkler head.

27. The method according to claim 21, further comprising:
disengaging the sprinkler system from the temporary chute once the construction or renovation project is completed;
dismantling the temporary chute; and
transporting the temporary chute and the sprinkler system away from the building.
